(19) United States
(12) Patent Application Publication
(10) Pub. No.: US 2022/0108632 A1
(43) Pub. Date: Apr. 7, 2022

(54) Physiologically-correct electro-mechanical Lung Simulator

(71) Applicant: Anthony David Wondka, San Ramon, CA (US)

(72) Inventor: Anthony David Wondka, San Ramon, CA (US)

(21) Appl. No.: 17/494,819

(22) Filed: Oct. 5, 2021

Related U.S. Application Data
(60) Provisional application No. 63/087,869, filed on Oct. 5, 2020.

(51) Int. Cl. G09B 23/30; G09B 23/32

(52) U.S. Cl. CPC G09B 23/303; G09B 23/32

(57) ABSTRACT

A lung simulator is described that models the anatomical structures and physiological functions of the lungs, using realistic and observable physical structures and mechanisms. For example, a diaphragm muscle that is optionally active, a pleural cavity with a visceral pleura viscously coupled to a parietal pleura, a physiologic tidal volume, a dead space volume, and CO2 production/diffusion, are physically modeled within the simulator. Pulmonary and breathing parameters can be set and monitored by the user to simulate the desired clinical situation, such as residual volume, lower airway resistance, CO2 production, expiratory flow limitation, work of breathing, atelectasis, pneumothorax and one-lung ventilation.

### CROSS-REFERENCED TO RELATED APPLICATIONS

This application claims benefit to U.S. Provisional Application No. 63/087,869 filed Oct. 5, 2020, the disclosures of which are hereby incorporated by reference in their entirety

### BACKGROUND

Artificial, mechanical lung models, or lung simulators, are a much-needed tool in respiratory medicine, and more particularly in bench studies testing ventilatory support equipment intended for therapeutic and diagnostic procedures. These lung simulators attempt to simulate the anatomy and lung mechanics. While not known to the general public, lung models are a required tool for respiratory equipment manufacturers, researchers, test laboratories and hospitals, equating to 10,000 to 20,000 institutions around the world that use and or require a lung model. Several existing lung models are available to these users, however, these lung models are either too complicated to use for the average and even the majority of users. In addition, they do not properly simulate the anatomical structures or the lung, nor the lung mechanics, and do not attempt to properly simulate the physiologic functions of the lung. These limitations cost the users unnecessary research and development delays because of training, learning curves, and retesting, and therefore extra financial costs. The limitations can also prevent the user from having a proper understanding of the interaction of the respiratory support device being tested, with the lung, which can lead to misleading conclusions, inferior studies, and unknown safety and efficacy problems.

In the prior art, Ingmar Medical markets the ASL5000 test lung model which is based on a piston that moves to represent a breathing or ventilated lung based on software algorithms that use the equation of motion. It is not stated in the available literature how accurate this simulator is, and it cannot model various aspects of the anatomy and physiology, such as pleural cavity pressure, lower airway dead space, residual volume, tension between the chest wall and lung, abdominal pressure, transpulmonary pressure, transdiaphragmatic pressure, or CO2 diffusion. It also has compatibility limitations, such as it cannot be used with humification. It also requires advanced, time consuming training to use, and calibration and repairs are very complicated, time consuming, expensive, and requiring return to the manufacturer.

Also in the prior art, Michigan Instruments markets the TTL test lung model that is based on an inflatable bellows, and importantly includes a resistance and compliance adjustment, and sensing ports to measure pressure inside the bellows. While a mainstay in the industry, this test lung does not simulate some important features such as lower airway dead space, the contribution of the pleural space to breathing mechanics, and other elements. The absence of these and other features can lead to misleading conclusions in certain clinical situations, possibly invalidating the simulation.

Also in the prior art a lung model has been described in which an ex-vivo porcine lung is placed into a chamber, and the air in the chamber drawn in and out in order to actively inflate and passively deflate the lung. While anatomically more correct than other prior art, this model has several limitations such as adjustability, consistency, durability. Other lung simulators are marketed and described in the literature as disclosed in Information Disclosure Statements to be provided as part of this patent application, each of which have limitations. Indeed, the limitations in the prior art significantly limit correct modeling of the lung mechanics, anatomy and physiology in research, healthcare and commercial settings. This incorrect and/or limited modeling found in the state-of-the-art lung simulators has not been completely addressed until finally now with the present invention. These important functional considerations were simply never solved because they were simply not obvious, and nor can a developer simply extrapolate form a variety prior art to create a correct lung simulator. Correct modeling requires deep understanding of the complexity lung physiology, which is difficult to understand because of the complex roles that the different anatomical structures play in breathing mechanics and physiological function. Even once these roles and interrelationships are understood, it is difficult and not obvious how to simulate these biological features in a synthetic man-made instrument. The more useful lung model described in this invention takes into account these complexities and deep knowledge of the respiratory system, creating for the first time, in a clever novel way, a man made bench lung model and simulator that, simulates all of the necessary anatomical structures and physiological functions for a proper simulation of breathing mechanics, yet while organizing it so that it is simple and intuitive to use. The anatomical and physiologic lung variables can be adjusted to accurately simulate the patient age and disease state. Reliable conclusions can be drawn when using it. As a side benefit of this ideal lung model, using it will give the user a much better understanding of the physical and physiological interaction between the therapy and the patient.

### SUMMARY

The lung apparatus described in this invention improves on the state-of-the-art for lung simulators or test lungs. In a first embodiment the lung is constructed of three compartments consisting of an outer pleural compartment, an alveolar volume compartment within the pleural compartment, and a lower airway dead space compartment in-series with the alveolar volume compartment. In a second embodiment the lung includes an adjustable and removable viscous coupling between the outer pleural wall and the alveolar compartment wall. In a third embodiment the lower airway dead space is of adjustable volume and resistance. In a fourth embodiment, the alveolar volume compartment is of an adjustable at rest baseline volume. In a fifth embodiment, a diaphragm structure is connected to the pleural compartment and a breathing effort actuator and an adjustable lung compliance spring is coupled to the diaphragm structure. In a sixth embodiment a CO2 production and diffusion system are coupled to the alveolar compartment. In a seventh embodiment a collapsible airway module can be installed to simulate COPD. In an eighth embodiment lung compliance and airway resistance can be adjustably set in a physiologically representative way. In a ninth embodiment an abdominal cavity is coupled to the diaphragm. In a tenth embodiment, pressure, flow, strain and gas composition sensors are provided throughout the simulator to measure and control lung function and simulation. Because the physical structures are obvious in their representation of real lung anatomy and physiology, that makes the simulator intuitive to operate, adjust and understand. As will be described in more detail subsequently, these embodiments, as well as additional embodiments, singularly or together, allow this lung model to more intuitively, accurately and completely simulate the lung compared to the prior art devices.

### BRIEF DESCRIPTION OF THE DRAWINGS

FIG. 1 is a front view line view of the lung simulator showing the 3 compartments, adjustable features, sensing ports, other anatomical structures, and user interface.

FIG. 2 is a top view of the view in FIG. 1.

FIG. 3 is a side view through the middle of the view in FIG. 1.

FIG. 4 is a front view of the left side of the simulator shown in FIG. 1, shown during a spontaneous breath effort.

FIG. 5 is the simulator shown in FIG. 4 with a mechanical breath being delivered into the lung, for example from a ventilator (not shown), after a spontaneous breath effort.

FIG. 6 is the simulator shown in FIGS. 4 and 5 during exhalation showing the air being passively exhaled.

FIG. 7 is a front line view of an alternative spontaneous breath effort actuator with a single actuator and U bracket actuating both the right and left lung.

FIG. 8 is a front line view of an alternative adjustable lung compliance spring with a single adjustment coupled to two springs connected to the right and left lung.

FIG. 9 is a line drawing front view of an alternative simulator with a spontaneous breathing effort actuator coupled to the underside of the diaphragm to pull the diaphragm, and with an adjustable lung compliance spring on the underside of the diaphragm, and showing adjustment readers, an adjustable lower airway module, a collapsible airway module, an upper airway humidification module, and a water drain.

FIG. 10 is a front line drawing view of the right side of an alternative simulator showing an abdominal cavity and independent compliances for the lung and chest.

FIG. 11 is a detailed view of Detail A in FIG. 10.

FIG. 12 is a schematic diagram of the lung simulator.

FIG. 13 is a schematic graphic of a computer based graphical user interface of the simulator.

FIG. 14 is a line drawing side view of the simulator with a face contour adaptor.

FIG. 15 is a side view of right lung side of an alternative simulator with multiple lung lobes, a heater, a temperature, pressure, humidity sensor, an upper airway humidification module and a lower airways collapsible tube module.

FIG. 16 is a line drawing front view of an alternative lung simulator with the residual volume adjustment part of an inner chassis, and with a lower airways volume adjustment.

FIG. 17 shows the lung simulator of FIG. 16 adjusted to a larger physiologic tidal volume.

FIG. 18 shows the lung simulator of FIG. 16 adjusted to a larger airways volume.

FIG. 19 shows the lung simulator of FIG. 16 during a spontaneous inspiration.

FIG. 20 shows the lung simulator of FIG. 16 during a mechanical inspiration.

FIG. 21 is a line drawing front view of an alternative lung simulator which has diaphragm deflection with a laterally sliding hinge, shown in a deflated resting state.

FIG. 22 shows the lung simulator of FIG. 21 in the inflated state.

FIG. 23 is a line drawing front view of an alternative lung simulator which has angular slides for a chest compliance spring, and a cardiogenic signal generator.

FIG. 24 is a line drawing front view of an alternative lung simulator which has a rigid uni-diaphragm plate deflectable with a flexible bellows attached to the enclosure side wall.

FIG. 25 is a line drawing front view of an alternative lung simulator which has a rigid uni-diaphragm plate and a flexible diaphragm membrane connected to the enclosure side wall.

FIG. 26 is a line drawing view of a lower airways resistance module with independent controls for inspiratory resistance and expiratory resistance.

FIG. 27 is a line drawing view of a collapsible lower airways module to simulate expiratory flow resistance, such as with COPD, show in the neutral resting state.

FIG. 28 shows the collapsible airway module of FIG. 27 during the expiratory phase showing the airway restricting.

FIG. 29 shows the collapsible airway module of FIG. 27 during the inspiratory phase showing the airway expanding.

FIG. 30 is a line drawing view of an upper airway resistance module with an obstructive sleep apnea collapsible airway simulation, with adjustable collapsibility.

FIG. 31 is a schematic representation of variable airways linear resistance mechanism.

FIG. 32 is a schematic representation of a variable airways parabolic resistance mechanism.

FIG. 33 is line drawing view of an endotracheal tube module which is insertable into the upper airway channel to simulator ET tube resistance, with a cuff leakage adjustment feature.

FIG. 34 is schematic view of an oxygen consumption module, which can be combined with the CO2 production module.

FIG. 35 is a plot with time on the x axis showing the lung simulators breath trigger response time measurement functions.

### DETAILED DESCRIPTION OF THE EMBODIMENTS

FIG. 1 shows the principal embodiments of the simulator LS1. The alveolar compartment 8 is within the outer pleural compartment 6. The outer pleural compartment 6 is created in between the visceral pleura 5 and parietal pleura 7. The lower airway compartment 9 is within the alveolar compartment 8. The diaphragm plate 3 is coupled to the visceral pleura 5 with a viscous coupler 20. The viscous coupler 20 can be disconnected such that the visceral pleura 5 and pleural cavity 6 are decoupled mechanically (not shown) from the diaphragm 3. Additionally, the viscosity of the coupling can be adjusted (shown later) such that the pleural cavity can be coupled to the diaphragm with varying degrees of force or tension. For example, a very low tension setting can simulate atelectasis so that lung recruitment and PEEP therapy can be properly tested. The lower airway compartment 9 simulates the tidal volume dead space of a real lung, so that the volume entering and exiting the lung can be differentiated between physiologic volume and dead space volume. In many clinical situations, this differentiation, unavailable in other lung simulators, is crucial to a proper simulation, and in drawing accurate, non-misleading conclusions. The lower airway compartment can have an adjustable volume or be replaceable with different volume sizes (shown later) in order to simulate different patient sizes. The lower airway compartment 9 includes apertures 19 for the air to enter the alveolar compartment from the lower airways, to simulate the distal airways leading into the alveolar units in the lung, and may include a filler material 18 that is used obtain the proper volume. Air is drawn into or pushed into the lung simulator through a main airway opening 15, which bifurcates into a left and right upper airway channel 16 which simulates the tracheal, main stem bronchi and lobar bronchi airways. An adaptor is provided (not shown) connectable to the airway opening to further simulate the trachea to accommodate insertion of a tracheal tube which is a good capability for some simulations. A lower airway resistance knob 17 is provided to set the required airway resistance. The air is drawn or pushed into the lower airway compartment 9 and through the apertures 220.

For the simulator to breathe spontaneously, the breathing actuator 12 is used to push down the diaphragm plate 3. At rest, the plunger of the actuator contacts the diaphragm plate with a dashpot 30 that is not attached to the plate, allowing the diaphragm plate to be pushed by forced in air beyond the position of the actuator, that is, a mechanical breath. Deflection of the diaphragm plate is a pivot about a hinge 4. The compliance or elasticity of the lung is adjusted by a spring 10, connected to the diaphragm with a coupler 24. The spring force is adjustable with an adjustment feature 31 in order to simulate all possible clinical situations, from stiff lungs in interstitial lung disease, to floppy lungs of chronic obstructive pulmonary disease, and the like. A mechanically strong bracket 29 is used to hold the breathing actuator and compliance adjustment in place without movement. The compliance spring attachment 24 may include a strain gauge (shown later) in order to measure the spring force, which can be used to determine work of breathing or the work imposed. When at rest, the alveolar volume compartment 8 assumes its natural resting volume, which should correlate to physiologic residual volume. With this simulator, the residual volume (RV) is adjustable to simulate various clinical situations and sized patients, using the RV adjustment mechanism 32. Notably, adjustment of RV by increasing the distance of the top enclosure 2 from the bottom enclosure 1, is importantly performed without moving the position of the diaphragm plate 3, breathing actuator 12 and lung compliance spring 10. Therefore, RV adjustment has no interdependence with other lung settings. Various pressure, flow and gas composition sensors, described in the reference symbols table, are placed throughout to measure the respective parameters in the respective compartments and airflow channels. The viscous coupling 20 and other features can be accessed by removal of a front cover 33 or rear cover 48 shown in FIG. 3.

Other features of the simulator LS1 include: A lung volume pressure sensing tap 21; a pleural cavity pressure sensing tap 22; an upper airway pressure sensing tap 23; a lung volume O2 sensing port 25; a lung volume CO2 sensing port 26; an upper airway O2 sensing port 27; an upper airway CO2 sensing port 28; an upper airway manifold 34; a sensing manifold 35; a pneumothorax valve 36; CO2 flow rate gauge 45; Actuator timer 50; left lung pressure gauge 51; left lung pleural pressure gauge 52; left lung lower airway pressure gauge 53; upper airway pressure gauge 54; right lung lower airway pressure gauge 55; right lung pleural pressure gauge 56; right lung pressure gauge 57; muscle force gauge 58; lung CO2 concentration gauge 59; CO2 feature enable switch 60; spontaneous breathing disable switch 61; spare display/timer 62.

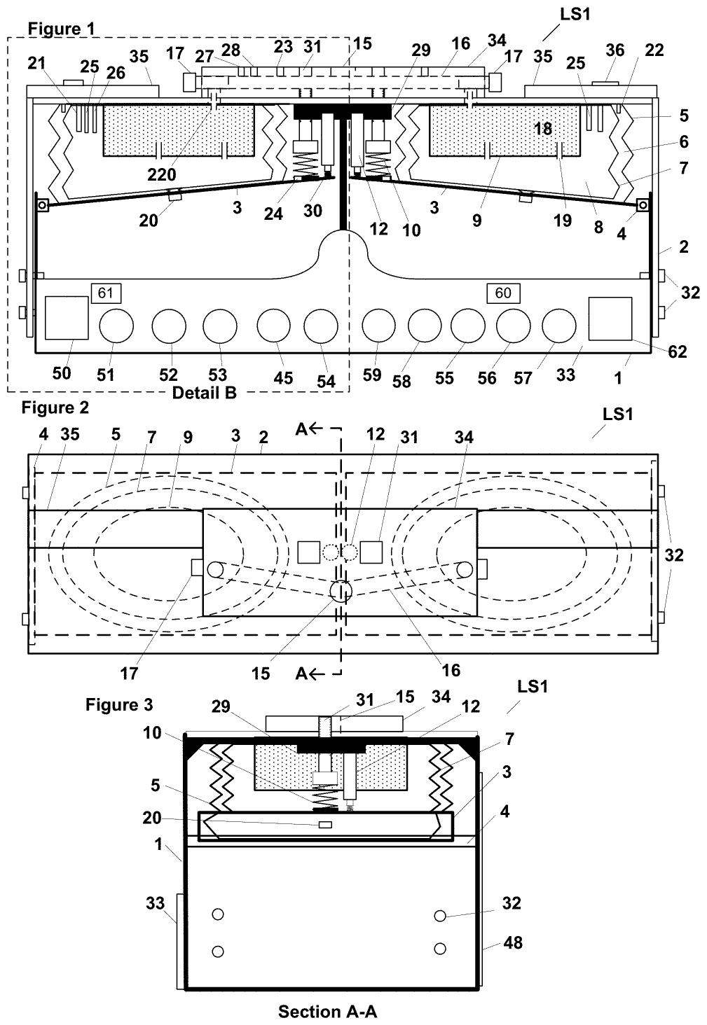

FIG. 2 shows a top view of the simulator of FIG. 1. In particular, the top view shows external access to the compliance adjustments 31, resistance adjustments 17, airway opening 15 and alveolar volume adjustment 32. FIG. 3 shows a side view through the centerline of the simulator shown in FIG. 1, in particular showing the mounting bracket 29 for the actuator 12 and compliance spring adjustment 31.

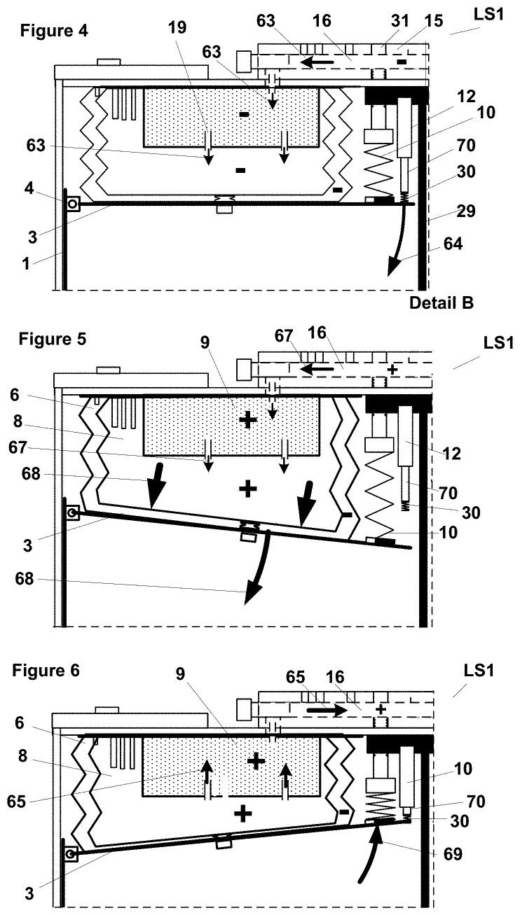

Now referring to FIGS. 4 through 6, the breathing of the lung simulator is described. In FIG. 4, the lung is shown during a spontaneous breath. The plunger 70 of the breathing actuator 12 has pushed down the diaphragm 3 to draw in under negative pressure spontaneously inspired air 63. FIG. 5 shows a mechanical breath taking over the breathing effort shown in FIG. 4. Air 67 is mechanically forced in under positive pressure. It can be seen that the force 68 of the mechanical breath deflects the diaphragm further and away from the spontaneous actuator, which again, is not firmly physically connected to the diaphragm. The actuator may be loosely physically connected to the diaphragm to allow separation, not shown, or not connected at all as shown. After the mechanical breath is complete, the lung is permitted to exhale shown in FIG. 6. The exhalation force 69 is governed by the various lung parameters such as the compliance 10, resistance 17, volumes, and external variables. FIGS. 4 through 6 shown the change in pressure in the alveolar compartment, changing from negative pressure during spontaneous breathing to positive pressure during the mechanical breath. Properly, the pleural cavity pressure remains negative, and the negative pressure increases and decreases as the lung breathes.

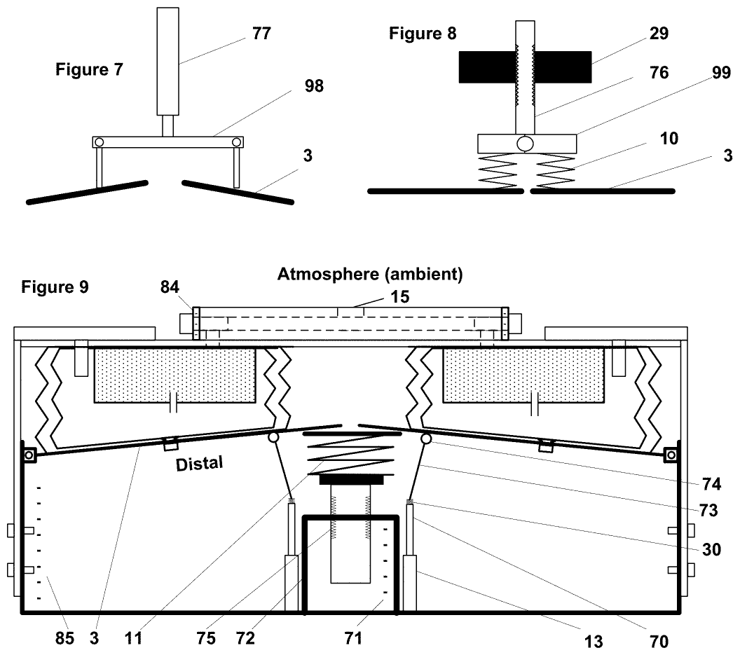

FIG. 7 shows an alternative breathing actuator in which a single actuator actuates both the left and right diaphragm through a U bracket. FIG. 8 shows an alternative lung compliance mechanism with a single adjustment mechanism coupled to a left and right spring through a coupler.

FIG. 9 shows an alternative arrangement of the breathing actuator and lung compliance spring. In this case the plunger 70 of the breathing actuator 13 pulls the diaphragm 3 downward during a spontaneous breath. The plunger is coupled to the diaphragm with a non-rigid cord 73 so that the diaphragm can be deflected independently of the actuator mechanism, such as during a mechanical breath. The cord is attached with a pivot joint 74 and a dashpot 30. Also, in this case the lung compliance spring 11 is below the diaphragm 3, such that it is compressed during breathing. The compliance spring is mounted to an adjustment mechanism 75 which is mounted on a lower bracket 72. A scale 71 is provided to inform the user where to set the desired compliance. A residual volume scale 85 and a resistance scale 84 are provided, and the scales electronically readable. For reference, the inlet to the lung simulator is known as the proximal end of the simulator, and the diaphragm is known as the distal end. It can be appreciated that the breathing actuator and lung compliance spring can be any combination of the embodiments shown, for example the actuator can be a single or dual actuator that either pushes or pulls the diaphragm, or the compliance spring adjustment can be a single or dual adjustment and the compliance spring can be a single or dual spring that elongates for a breath or compresses for a breath.

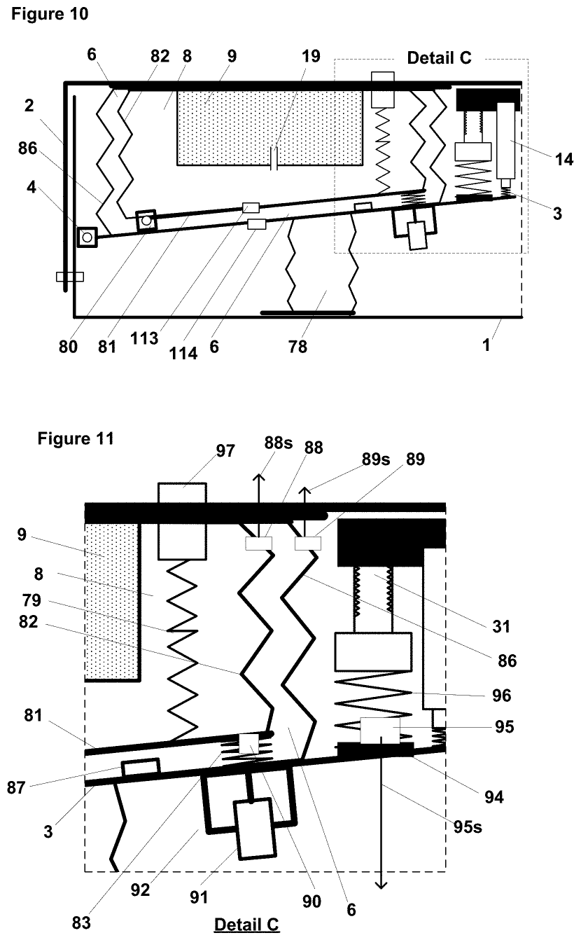

FIG. 10 shows an alternative embodiment of the simulator. For clarity, just the right side of the simulator is shown and without the upper airway or sensing manifolds shown. An abdominal cavity 78 is coupled to the diaphragm plate. The pressure is monitored in the abdominal cavity so that transdiaphragmatic pressure can be measured and controlled. A separate lung compliance force 79 and chest compliance force 96 are provided, each adjustable with adjustment features 31 and 97. The inner lung volume compartment 8 includes a base 81 attached to the lung wall 82, and the base 81 is pivot-ably attached to the diaphragm plate 3 with an attachment 80. There is also a drain 113 accessible through a drain access port 114 in order to drain the lung compartment after performing tests with heated humidification. The drain can be accessed by opening a front cover to access the inside of the apparatus. In detail A shown in FIG. 11, some additional details are described. The chest wall or visceral pleura 86 includes a strain gauge sensor 89, and the lung wall 82 includes a strain gauge sensor 88, the sensors providing information about how much these structures are being stressed, for monitoring of and/or control of the stress index. The tensions of the compliance of the chest 96 and the compliance of the lung 79 is measured by sensors 89 and 88. The viscous coupling between the chest wall and lung wall 83 can be adjusted with the viscous adjustment 91 affixed to a bracket 92, and this viscosity can be measured with a sensor 90. A dampening cushion 87 absorbs any shock that could be created by sudden knocking of the diaphragm 3 to the lung volume base 81. The strain gauge signals are depicted 88s, 89s and 95s.

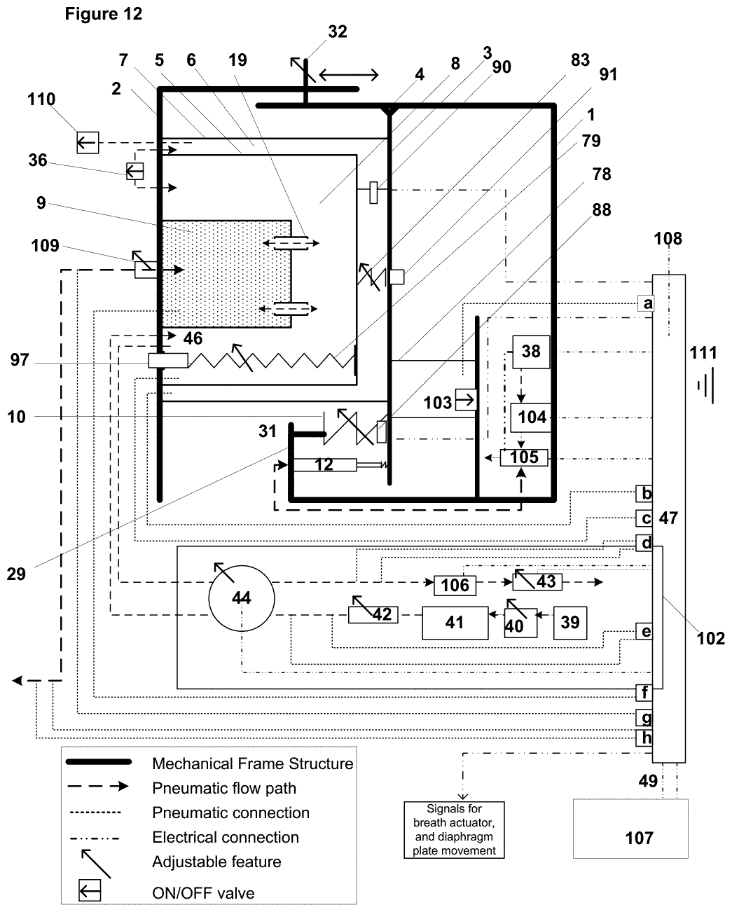

FIG. 12 shows a mechanical, electrical and pneumatic schematic diagram of the lung simulator. Shown in this figure is the CO2 production and diffusion module 80. This feature adds the functionality of diffusing CO2 gas, at the correct rate, into the lung alveolar compartment. This feature allows the user to determine how well CO2 is being removed from the lung, and if there is any CO2 retention. The module may include an injection pump and a removal pump, with flow rate measurement and control and an inline CO2 sensor, and a feedback control to create the correct CO2 level. The amount of CO2 production required to be set will be provided to the user. For example, for an average size healthy adult patient breathing at rest at 400 ml tidal volume breaths at 12 bpm, with 5% CO2 being exhaled on each breath, the diffusion rate of the CO2 into the lung should be 240 ml per minute. The various features are listed in Table 1, and described by virtue of their names which serve as descriptions. FIG. 11 also shows an adjustable tension dashpot interconnecting the visceral and parietal pleura. The dashpot can be adjusted in order to simulate different levels of lung collapse. Lung collapse can occur in respiratory and pulmonary compromised patients. PEEP therapy counteracts the tendency of lung collapse. A pneumothorax valve is also shown. To simulate a pneumothorax that can occur from barotrauma to the lung, the valve is opened, which causes inspired air to leak into the pleural space. A pleural pressure adjustment port is included which can be used to set a particular pressure in the pleural space. Under normal clinical conditions the pleural space is a closed compartment under negative pressure, around −5 cmH2O at rest, however under various abnormal clinical situations the pressure in the pleural space may vary. The ability to set this pressure for to be representative of the patient is critical to a valid simulation. A metering pump module is described which drives a pneumatic breathing actuator. The metering pump is controlled by a pressure and time setting and a solenoid valve to deliver and evacuate the air pressure signal. A water drain is provided to dry out the lung after use with an external heated humidifier. A circuit board assembly is described that includes the sensors that measure the various parameters, signal processing, control functions, and data input and output functions. The circuit board assembly has a power input and a data input and output. Data can be outputted and inputted from/to the circuit board either by a hard cable or by a wireless transmission. A computer user interface is available to monitor, and in some cases control the various features of the lung simulator. The computer program includes a virtual lung graphic, which breathes according to the simulator, so that the user can relate to a real live actual lung. Refer to the reference symbol table for a description of the various elements.

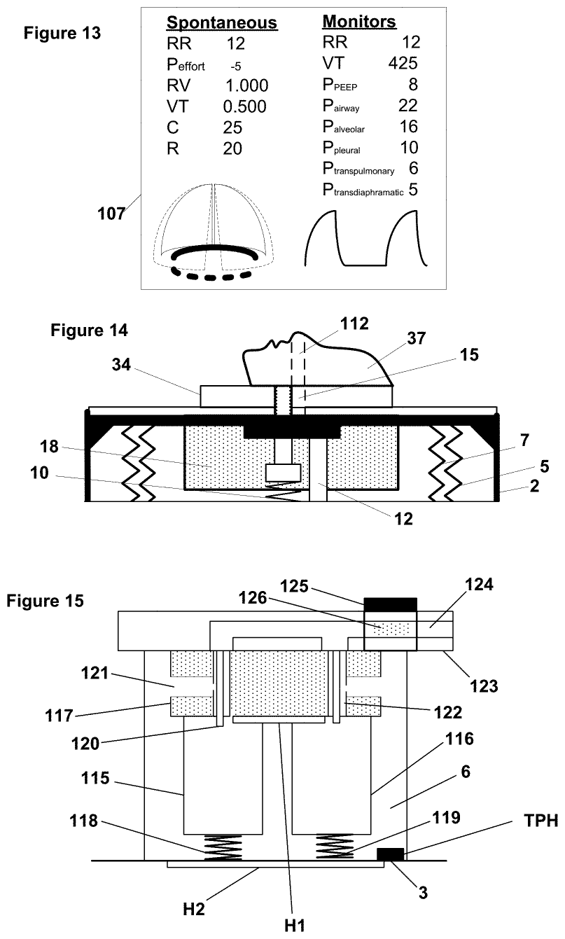

FIG. 13 shows an exemplary alternative and optional digital user interface 107 existing on a computer display screen, in addition to the analog/digital user interface shown in FIG. 1. A benefit of the simulator in this invention, is that a laptop computer may conveniently be positioned on the top of the simulator, as seen in FIG. 25. With the prior art, due to the inherent design and construction of the prior art simulators, if a computer is used in conjunction with those simulators, the computer must be located and positioned away from the simulator, which is often problematic. The benefit of positioning the computer user interface on the top surface of the simulator as with this invention is that the user can see the simulator features and structures and the digital user interface in one view. Also, this arrangement takes up less laboratory space, which is important in some settings like a hospital clinical engineering lab or the respiratory therapy equipment room. If it is important that the simulator be moveable or transportable, this form factor allows it to be positioned with the computer interface on a small footprint cart or mobile stand as shown in FIG. 25, making it easy to move around a laboratory or a hospital.

FIG. 14 simply shows a facial contour adaptor 37 which is connectable directly to the airway opening 15 of the upper airway manifold 34. This adaptor can be used to perform simulations and testing when a non-invasive mask is being used to provide ventilatory support to the patient.

FIG. 15 describes additional alternative features of the lung simulator. In this case two lung segments are within the outer compartment or the chest compartment or pleural space. The two lung segments, 115 and 116, can simulate two lung lobes or two lung segments, or a left and right lung. Each segment is separately attachable with a spring force to the chest wall or diaphragm plate 3 with spring type structures 118 and 119. One or both of the spring type structures 118 and 119 can be detached from the diaphragm plate 3 in order to create a localized lung section collapse, so the user can perform lung recruitment maneuvers to treat lung collapse, atelectasis or pneumothorax. A collapsible lower airway module 117 is provided to simulate the airway collapse and airflow limitation that occurs in COPD, which includes a camber 122 connected to the pleural cavity 6 through a channel 121. The airways collapse and become more resistive particularly during exhalation. An upper airway 124 humidification module 125 is provided which produces the correct amount of upper airway humidification 126 which can be used to simulate the production of humidity by the nasal sinuses, to allow for the realistic testing of a heat moisture exchanger external to the lung simulator, for example when performing tests of non-invasive ventilation applications. The lower airway volume can be modeled by an adjustable lower airway volume adjustment 109 (FIG. 12) or a modularly replaceable lower airway volume compartment 117, in order to simulate different lung sizes.

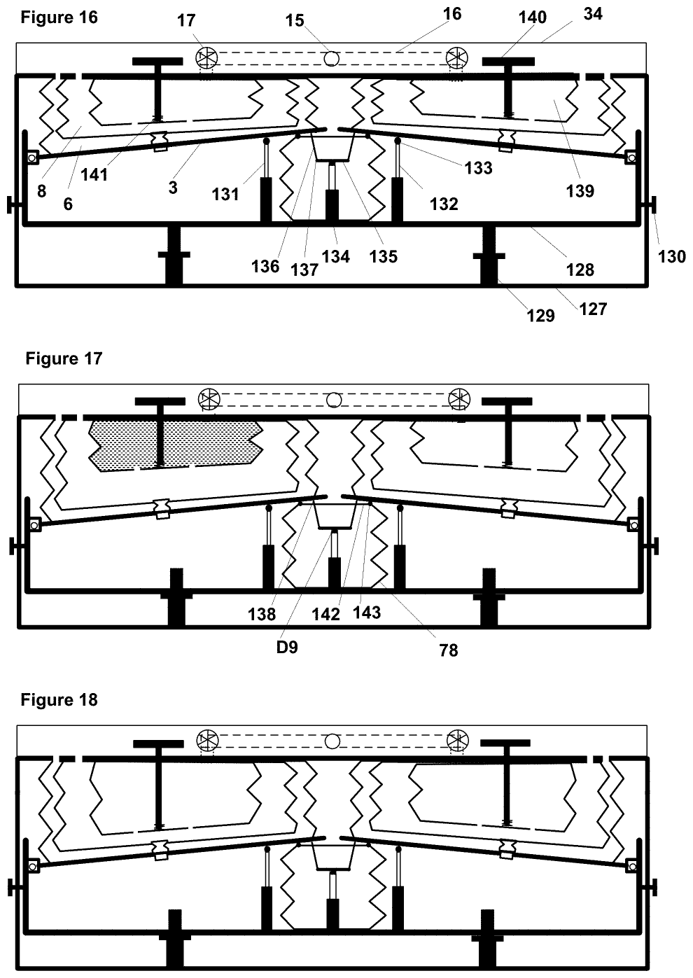

FIGS. 16 through 20 show an alternative residual volume adjustment embodiment in which the overall outer dimensions of the simulator do not change when the volume adjustment is made. An inner chassis 128, which is used to set the lung volumes, is inside an outer enclosure 127. The upper airway manifold rests on top of the outer enclosure. The top of the lung compartments are fixed to the inside top of the outer enclosure, and the bottom of the lung compartments are coupled to the inner chassis by means of the diaphragm plates which are connected to the side walls of the inner chassis. The inner chassis can be raised or lowered with respect to the outer enclosure which changes the bottom position of the lung compartments and diaphragm muscle plate(s). The chassis adjustment is made possible by an adjustment mechanism which can be an adjustment rod, screw or other mechanism, which can be manually actuated or automatically actuated. Retention clamps may be provided to secure the position once set to the desired volume. FIG. 16 includes an adjustable lower airways volume 139, and shows the residual volume set to a relatively low normal volume, such as for example 1.25 liters (combined left and right lungs), representing a small adult without any hyperinflation of the lungs. FIG. 17 shows the residual volume set to a relatively high residual volume, for example 4.0 liters (combined left and right lungs), representing an average size adult with moderate to severe hyperinflation caused by COPD. The difference in inner chassis position, and hence the resting volume of the lung compartment can be seen comparing FIGS. 16 and 17. As can be seen, the lowering of the diaphragm plate in FIG. 17 increases the internal volume of the chest compartment (i.e., pleural cavity) as well as the alveolar volume compartment, which is viscously coupled to the chest wall with a viscous coupler. Now, because the lower airways volume is fixed to the inside top of the outer enclosure where it is pneumatically coupled to the upper airway manifold positioned on the outside top of the outer enclosure, the lower airways volume is not changed in this embodiment when the volumes of the pleural and alveolar compartments are changed. As such, there is an independent volume adjustment 140 for the lower airways volume compartment(s). A dampener D9 is included to dampen tension and compression between the actuator and actuator plate 135. In FIG. 18, in comparison to FIG. 17, it can be seen that the lower airways volume is adjusted to for example 1.5 liters (combined left and right lungs).

Continuing to describe the FIG. 16 simulator, FIGS. 19 and 20 show inspiratory inflations of the simulator. In FIG. 19, a patient's spontaneous inspiration is simulated by means of pulling down on the two lung diaphragms with a breath actuator 134. In this case the expansion of the chest volume pulls air into the lung alveolar compartment. The actuator is affixed to the diaphragm plates by cables 136. Chest compliance elements 131, 132 are positioned below the diaphragm. The abdominal cavity top plate includes bearings so that the lateral motion between the diaphragm plate and top plate which occurs when the diaphragm plates compress down on the abdominal plate, has minimal friction. Likewise, the tops of the compliance elements include bearings so that the lateral motion between the elements and diaphragm plates has minimal friction. In FIG. 20, a mechanical inspiratory inflation from a ventilator is shown. In this case the forced air inflation of the alveolar lung compartment pushes to inflate the pleural compartment, which deflects the diaphragms downward. The breath actuator cables simply flex out of the way. Also as can be seen in FIGS. 19 and 20, the lower airways volume increases somewhat during the lung inflation, for physiologically correct modeling. With a real lung, during inflation not only does the thoracic cage and the alveolar compartment volumes increase, but the lower airways volume increases due to dynamic dilation of the bronchial tubes during the inspiratory cycle. The lung structures are all tethered indirectly to the thoracic cage, and therefore during inspiration, these structures, including the airway volume, increases. In the present simulator, this dynamic volume increase of the airways volume is made possible by a spring-type connection between the airway compartment and the volume adjustment mechanism.

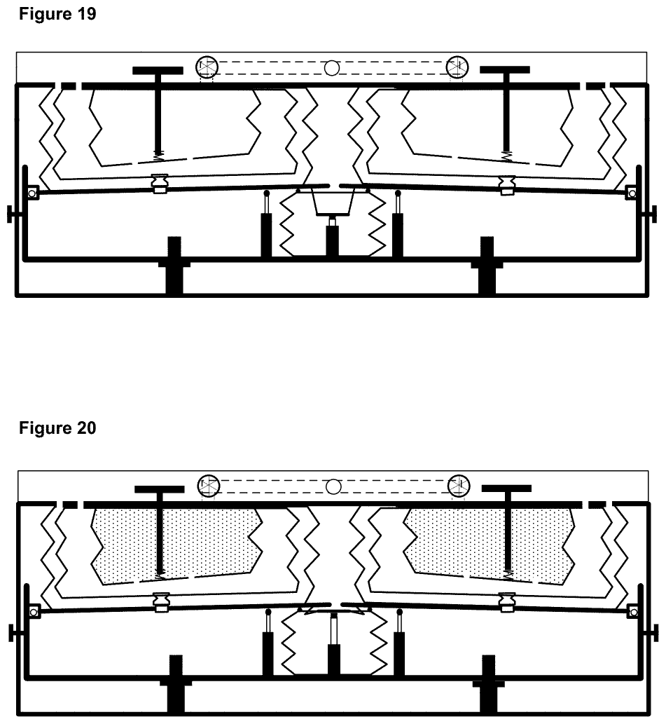

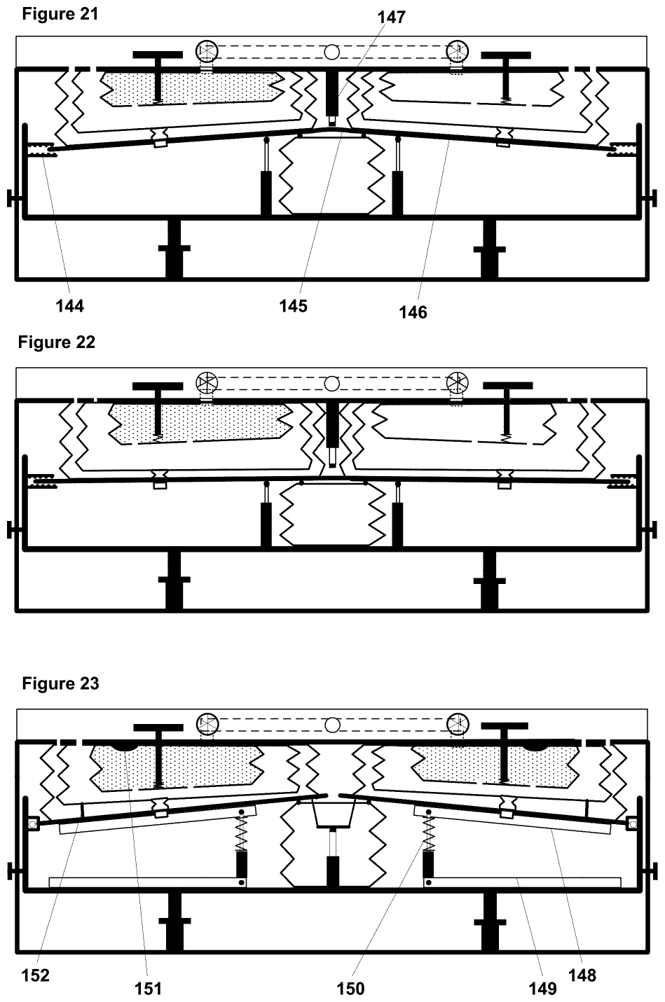

In FIGS. 21 and 22, an alternative diaphragm is described. In this case there is a single uni-diaphragm 146, with lateral hinges 144 that allow the diaphragm plate to slide laterally outward when the diaphragm is flexed downward and to slide inward when the diaphragm plate flexes upward. The sliding hinges are surfaced with bearings, or the like, to allow friction free lateral movement of the diaphragm plate within the hinge. The center area 145 of the diaphragm, where the breath effort actuator 147 is attached is convex shaped and flexible but not stretchable. When this section is deflected downward, it flexes from a curved shape to a straight shape, which pushes the lateral edges of the diaphragm outward. This section can be flexed further downward (now shown) if a larger inspiratory breath is desired, which will curve the section in the opposite direction and the lateral edges will slide medially. In FIG. 21 the simulator is shown in its resting state, or delated state, and in FIG. 22, the simulator is shown in an inflated state, inflated partially from a partial inspiratory effort and inflated the remainder of the way with a mechanical breath from a ventilator. Again, as previously described, the lower airways volume increases moderately during the inflation cycle, as would be expected in real life, due to the spring coupling between the airways volume compartment and the adjustment mechanism which is affixed to the top of the outer enclosure and/or the upper airway manifold.

In FIG. 23 an alternate chest compliance adjustment system is described. Slide rails 148, 149 are included at the underside of the diaphragm plates and the topside of the inner chassis bottom. A sliding compliance spring is adapted to be placed between the upper and lower slide rails and can slide laterally within the rails. The closer the springs are to the center the stiffer or more elastic is the lung and chest, and the more lateral the springs are the less elastic the lungs are. The slides are labeled with a precision scale (not shown) to guide the user on how to set the desired compliance. This compliance setting will be independent of the residual volume setting, and independent of the lung volume measurements. A similar sliding compliance spring can be equipped between the diaphragm and alveolar volume compartment for setting and adjusting the lung compliance. A cardiogenic vibration emitter is also shown in FIG. 23, which can be an important feature in a simulator when users are testing equipment to ensure the control algorithms are not fooled by pluses that show up in the lung and breathing circuit that are caused by the heart. The amplitude and frequency of the pulses is adjustable.

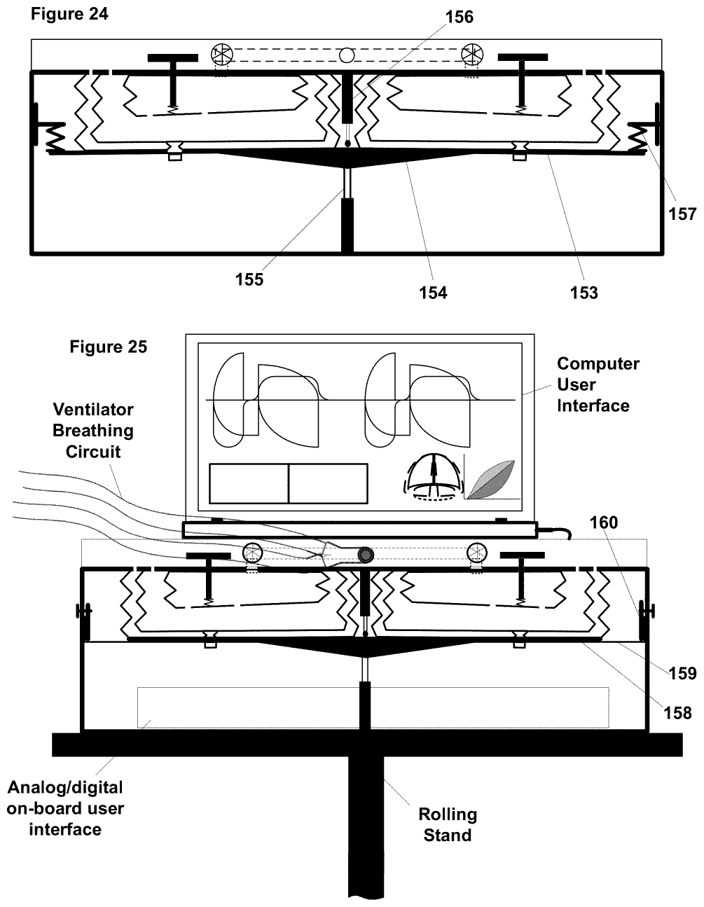

In FIG. 24 an alternative lung simulator is shown in which there is a single uni-diaphragm plate 153, which is coupled to the inner chassis side wall with a flexible bellows hinge. A single compliance spring element 155 is connected to the diaphragm plate through an anti-wobble strut structure to help make the diaphragm move down and up in a substantially uniformly horizontal manner. In FIG. 25, an alternative embodiment is shown in which the diaphragm plate is a rigid plate, to which a flexible, stretchable membrane is attached. The membrane is attached to the inner chassis side wall. A section of the membrane that is between the chassis side wall and the side edges of the rigid diaphragm plate, is stretched and flexed downward during an inflation cycle, and the memory of the membrane material causes its passive return to the resting position when the inflation forces are not present.

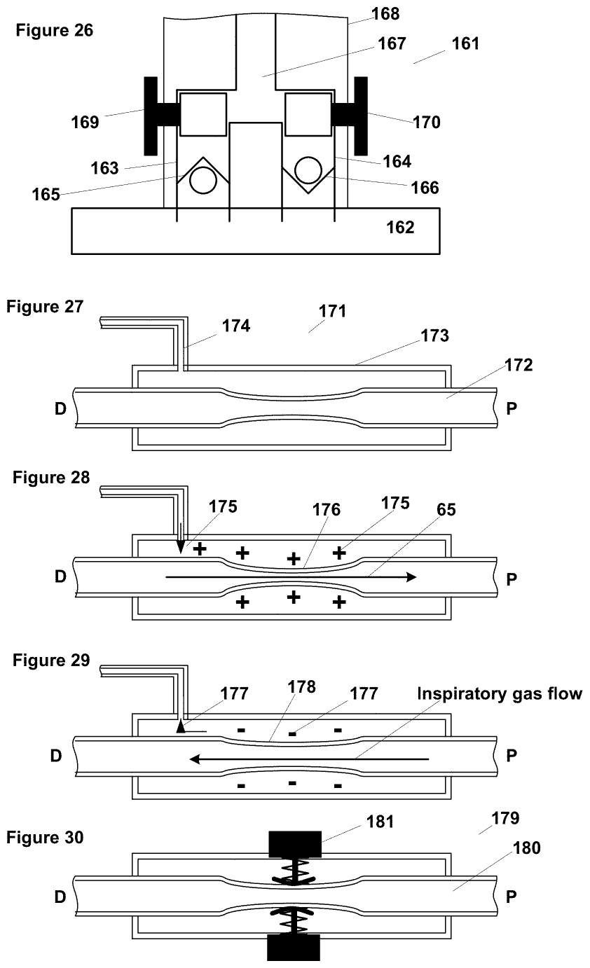

FIG. 26 describes a lower airways resistance mechanism in which resistance levels can be independently set for the inspiratory flow direction and the expiratory flow direction, thus allowing for the possibility of different inspiratory and expiratory resistances. This is accomplished by the use of separate inspiratory and expiratory flow path sections with one-way check valves, and a resistance setting in each path. As described elsewhere, the resistance settings can have linear or parabolic resistances, and can be manually or automatically set, and can have an array of discrete setting values or can be a continuum of valves.

FIGS. 27 through 29 show a lower airways expiratory flow limitation feature. In COPD, during exhalation, the airways may restrict due to the altered lung anatomy that the disease causes. With this feature, a flow path tube includes a collapsible section which is surrounded by a compartment. In FIG. 28 the feature is shown during exhalation with flow traveling from distal to proximal. A pressure signal is applied to the compartment via a pneumatic tap that is connected to elsewhere in the system, causing a positive pressure surrounding the collapsible section of the flow tube, thus further restricting that section of airway, and increasing the resistance during exhalation. During inspiration, shown in FIG. 29, a negative pressure is applied in the compartment through the pressure tap line, and the negative pressure expands the collapsible section of the flow tube, thus reducing resistance to flow during inspiration.

FIG. 30 describes an upper airway collapsible airway feature. A flow tube representing the upper airway includes a potentially collapsible section, and a pinching mechanism is included at the outside of this section. During inspiration, the pinching mechanism can be controlled to pinch this section of tubing, and during exhalation, the pinching action is discontinued. The automatic actuation of the pinching mechanism can be automatically synchronized with the breathing cycling by measuring the flow or pressure in the gas flow path. Springs within the pinching mechanism can make sure that the resting state of the pincher is open and not in the pinching state. The pinching mechanism is designed such that positive pressure inside the flow tube can counteract the pinching forces and prevent pinching. The decree of pinching force is adjustable so that there can be a range of pinching forces ranging from a low pinching force to a high pinching force. This feature can be used by users that are studying obstructive sleep apnea, which is a condition in which the upper airway collapses during inspiration, making it difficult to breathe.

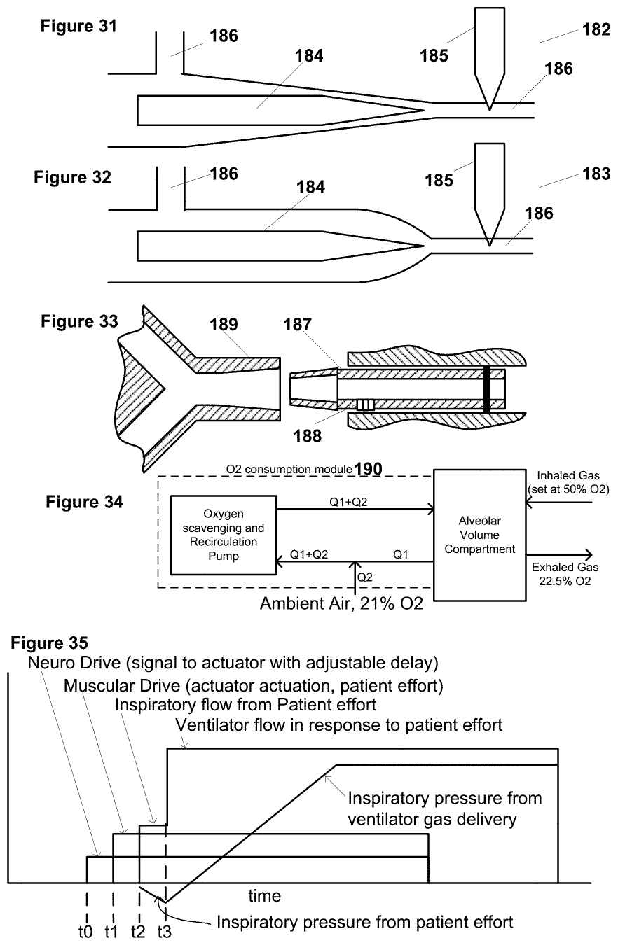

In FIG. 31 an adjustable linear airway resistance mechanism is shown in which a needle or pincher is used to change the flow cross section to adjust the resistance continuously within a minimum and maximum range. The gradually tapered body creates the linear resistance profile. In FIG. 32 a parabolic airway resistance mechanism is shown, in which case a curved shoulder in the flow body creates the necessary flow turbulence to produce a non-linear resistance curve.

In FIG. 33 an endotracheal tube resistance insert is described. In order to simulate the resistance of an endotracheal tube, rather that cobbling together ET tubes and adaptors, an insert is simply provided to insert into the upper airway manifold. A set of inserts may be provided, ranging from small ET tubes to large ET tubes, to allow the user to conduct the necessary simulation. The breathing circuit wye connector can easily connect to the ET Tube insert. The ET Tube insert may also include an adjustable leak valve, so that the user can simulate the effects of a leak around the cuff of the ET tube, which often is an important consideration when evaluating patient-ventilator interaction. This ET tube insert feature obviates the need for the simulator to attempt to simulate the ET tube resistance by use of the overall system resistance setting. Again, this provides a much more realistic simulation by allowing the user to think about artificial airway resistance and physiologic airway resistance separately.

FIG. 34 describes an oxygen consumption module which allows the user to simulate the consumption of oxygen within the lung as would occur in real life. With this feature the user can monitor the exhaled oxygen concentration as one of many factors to determine the effectiveness of the therapy being studied and to conduct a realistic simulation. The amount of oxygen removed from the lung may be set by a valve that controls the flow Q2 coming in from ambient air and the speed of the recirculation pump flow rate Q1+Q2. The greater the flow Q2, the lower the exhaled gas O2 concentration. The oxygen is typically withdrawn from the alveolar lung volume compartment, deep within that compartment, to properly simulate the physiologic function of the lung's gas exchange functions, rather than removing the oxygen higher up in the respiratory tree. A simple mathematical formula is provided that allows the user to either manually set the amount of oxygen consumption, or control it automatically with an algorithm and control system, based on the desired inputs from the user. The oxygen consumption module can be combined with the carbon dioxide production module, described previously, into one integrated gas concentration control system. The oxygen and carbon dioxide combined gas concentration control system can be used in conjunction with other features previously described to perform a wide array of simulations. For example, end-tidal CO2 monitoring equipment can be tested with this simulator, including for example modeling different spontaneous breathing patterns with which the simulator is breathing. For example, the simulator can be set to simulate the breathing of a patient with emphysema, with the correct residual volume, inspiratory and expiratory times, breath rate, expiratory resistance, and CO2 production and O2 consumption. Or, the simulator can be set to simulate an erratic, fast, episodic and non-steady-state breathing pattern of a neonate, for example if the simulator is being used to test exhaled carbon monoxide monitoring equipment. With a digital computer-based control system, the simulator can literally be set to realistically simulate any desired breathing pattern.

FIG. 35 is a graph showing how the simulator can provide information to the user to study the responsiveness of the therapy that is being evaluated, to the patient's actions. In conjunction with the features described in FIG. 12, signals may be provided and can be measured that correspond to the simulator's neurological drive to initiate a breath, and the simulator's muscle to initiate a breath. There can be a delay circuit or delay component between the neurological effort and the muscle effort to correspond to a real live body in which there may be a delay between the neurological drive and the actual motion of the respiratory muscles. The inspiratory airflow and inspiratory pressures throughout the respiratory system is also measured with the sensors described previously. Together this measured information can give the user an accurate picture of the responsiveness of the respiratory support equipment to the patient's breathing effort. Equipment responsiveness to other phases of the breathing cycle may also be studied, such as the equipment's response to the end of inspiration or the beginning and end of exhalation.

Some additional features may be included in the simulator. For example, a forced exhalation maneuver, or cough, can be simulated by for example using the actuator shown in FIG. 23 which can be commanded to use the actuator plate 135 to push up on the diaphragm plates if desired. All of the adjustable and/or settable features and functions can be set either manually, or the requisite electromechanical control system may be included to make the adjustment, such as but not limited to the lower airways resistance setting, the upper airway resistance setting, the endotracheal tube resistance setting, the lower airways volume, the lower airways dynamic volume increase, the residual volume, the thoracic cage volume, the pleural space volume, the alveolar lung compartment volume, the compliances, the CO2 production and O2 consumption rates, the breathing effort, pleural adhesions, pneumothorax leak rate, and pleural pressure. Each different anatomical structure and/or physiological function may be modular, so that it can be replaced or added on an as needed basis. For example, neonatal and infant size patients can be simulated by switching out larger components with smaller components, and keeping the same sensors and electronics, rather than requiring the user to purchase two separate systems. The simulator offers two ways of operating it—it can be operated without the use of a computer with on-board visual gauges and user settable control components such as timers, or can be operated with a computer in which case the computer serves as the main user interface, control system and monitoring system. A venous oxygen module may be provided, to which a pulse oximeter monitoring device can be attached, in order to simulate and monitor the patient's SpO2. The chest and lung compliance springs may be three phase springs such that the force-displacement curve is a S shaped or Z shaped curve. Additional flow sensors may be provided which are attached to the ventilator breathing circuit to measure flow from a ventilator that is bypassing the lung. Algorithms may be provided to measure various respiratory parameters, such as tidal volume, alveolar plateau pressure, intrinsic PEEP and other parameters. The lung simulator can be set up to perform spirometry maneuvers, in which residual volume, forced exhaled tidal volume, forced inspired volume, total lung capacity, and other lung volumes can be simulated and measured. The airways resistance setting mechanism may allow the user to set either linear or parabolic resistances in one control mechanism. Compliance my be set and controlled with an electro-mechanical actuator or pneumatic actuator. An element may be provided to study the effects of prone therapy versus normal body position. The simulator may take into account different patient age groups that the simulator models, from neonatal to adult, and as such may be available in 3 size ranges, each size capable due to the adjustability described above, of simulating the entire age group

In the various embodiments described above, the various sections of the simulator have pressure, flow, strain, position, and gas composition sensors (listed in Table 1) to measure and/or control the various physiologic functions of the simulator. These functions include residual volume, inspired and exhaled tidal volume, spontaneous breath effort, upper airway pressure, lower airway pressure, alveolar pressure, pleural pressure, abdominal pressure, transpulmonary pressure, transdiaphragmatic pressure, lung wall stress, chest wall stress, stress index, residual volume, PEEP, PIP, MAP, FEV, FVC, CO2, O2, breathing effort, work of breathing, lung compliance, airway resistance, etc. This information is made available to the user with gauges on the front panel and or through a computer-based user interface.

The lung simulator may further comprise (1) a proximal end and a distal end, the proximal end representing the atmospheric entrance into the lung, and the distal end representing the section of the inner or outer lung compartments furthest away from the proximal end, (2) a diaphragm plate coupled to the outer compartment distal end, and (3) a third compartment coupled to the side of the diaphragm plate opposite to the outer compartment, the third compartment representing the abdominal cavity. The lower airway volume sub-compartment may further comprise an adjustment, the adjustment adapted to set the sub-compartment to a first defined inner gas volume and a second defined inner gas volume. It may further comprise an upper airway humidity generator, the generator representing humidity produced by an upper airway. It may further comprise (1) a first pressure in the outer compartment, (2) a second pressure in the physiologic volume sub-compartment typically normally greater than the first pressure, (3) a pneumatic interconnection between the physiologic volume sub-compartment and the outer compartment, the interconnection openable to equalize the pressure in the two compartments rather than the typically normal pressure differential. It may also comprise pressure monitoring sensors, flow monitoring sensors, position sensors, strain gauge sensors and gas composition sensors, measuring parameters to determine RV, VT_{inspired}, VT_{exhaled}, Lung C, Chest C, Dynamic C, Static C, Airway R linear, Airway R parabolic, P_{upper airway}, P_{lower airway}, Pₐₗᵥₑₒₗₐᵣ, Pₚₗₑᵤᵣₐₗ, P_{abdominal}, P_{transpulmonary}, P_{transdiaphramtic}, Stress Index, lung wall stress, chest wall stress, WOB, CO2, O2, RR, Minute Volume, MAP, AutoPEEP, dynamic hyperinflation, FEV, FVC, Q_{inspired}, Q_{exhaled}. The structures of the simulator are arranged in a manner to visually represent the anatomy of the lungs in a physiologically correct representation, the representation relatable to a un-trained user, the structure arrangement and physiologically correct relatable representation allowing ease of operation and interpretation such that the user can relate to the structure and function and therefore perform their necessary function better.

As can now be appreciated by the foregoing descriptions, the lung simulator described in this invention uniquely provides for the first time a proper simulation of lung mechanics, lung anatomy and lung physiology in one simulator. The simulator is easy to use, intuitive and is a fully featured lung simulator to properly simulate the lung physiology and mechanics during various forms of breathing interventions. The different embodiments described, can be combined with one another to create the ideal embodiment, and for brevity all and each of these useful combinations are not explicitly listed.

Table 1 lists the description of each of the reference symbols used in the Figures. For brevity, the symbol number may not be repeated in the description, and the reader is asked to cross reference the table and the drawings.

TABLE 1
Description of Symbols used in the Figures

| | | | |
|---|---|---|---|
| 1. | Bottom Chassis | 53. | Left Lung lower airway pressure gauge |
| 2. | Top Enclosure | 54. | Upper airway pressure gauge |
| 3. | Diaphragm Plate | 55. | Right Lung lower airway pressure gauge |
| 4. | Diaphragm Plate Hinge | 56. | Right Lung pleural pressure gauge |
| 5. | Visceral Pleura | 57. | Right Lung pressure gauge |
| 6. | Pleural Cavity | 58. | Muscle force gauge |
| 7. | Parietal Pleura | 59. | Lung CO2 concentration gauge |
| 8. | Alveolar Lung Volume (Physiologic), Vphy | 60. | CO2 feature switch enable |
| 9. | Lower Airway Volume (Dead space), Vdsla | 61. | Spontaneous breathing disable switch |
| 10. | Compliance tension spring | 62. | Spare display or timer |
| 11. | Compliance compression Spring | 63. | Spontaneous inhaled gas |
| 12. | Spontaneous breathing push actuator | 64. | Spontaneous inhaled breath effort force |
| 13. | Spontaneous breathing pull actuator | 65. | Exhaled gas |
| 14. | Spontaneous breathing linear actuator | 67. | Mechanically delivered gas |
| 15. | Airway opening and connection to atm. | 68. | Mechanical inhaled breath force |
| 16. | Upper airway channel | 69. | Exhaled muscle force |
| 17. | Airway resistance adjustment | 70. | Actuator plunger |
| 18. | Lower airway dead space filler | 71. | Compliance Scale |
| 19. | Lower airway apertures | 72. | Compliance spring bracket |
| 20. | Visceral-Parietal Pleura connector | 73. | Tether |
| 21. | Lung volume pressure sensing tap | 74. | Tether hinge |
| 22. | Pleura cavity pressure sensing tap | 75. | Compliance compression spring adjust |
| 23. | Upper Airway pressure sensing tap | 76. | Dual compliance adjustment bar |
| 24. | Breathing muscle strain gauge | 77. | Dual lung breathing actuator |
| 25. | Lung volume O2 sensing port | 78. | Abdominal cavity |
| 26. | Lung volume CO2 sensing port | 79. | Lung wall compliance |
| 27. | Upper airway O2 sensing port | 80. | Lung wall anchoring point |
| 28. | Upper airway CO2 sensing port | 81. | Lung wall base |
| 29. | Actuator support bracket | 82. | Lung wall |
| 30. | Actuator-diaphragm dashpot | 83. | Lung wall to Chest wall viscous attraction |
| 31. | Compliance adjustment | 84. | Resistance Scale |
| 32. | Residual Volume adjustment | 85. | Residual Volume Scale |
| 33. | Front panel | 86. | Chest wall |
| 34. | Upper Airway manifold | 87. | Diaphragm to lung base dampener |
| 35. | Sensing manifold | 88. | Lung wall strain gauge |
| 36. | Ptx valve | 89. | Chest wall strain gauge |
| 37. | Non-invasive mask airway adaptor | 90. | Transpulmonary strain gauge |
| 38. | Actuator drive pump | 91. | Viscous force adjustment |
| 39. | CO2 gas cartridge | 92. | Viscous force adjustment bracket |
| 40. | CO2 pressure/flow regulator | 93. | Strain Gauge signal |
| 41. | CO2 gas accumulator | 94. | Chest compliance spring connector |
| 42. | CO2 diffusion metering pump | 95. | Chest compliance spring strain gauge |
| 43. | Gas return balancing pump | 96. | Chest wall compliance spring |
| 44. | CO2 delivery and return balancing pump | 97. | Lung wall compliance adjustment |
| 45. | CO2 flow rate gauge | 98. | Dual lung breathing actuator fork |
| 46. | CO2 delivery port | 99. | Dual lung compliance knuckle |
| 47. | Printed circuit board | 102. | CO2 diffusion module |
| 48. | Rear panel | 103. | Abdominal cavity pressure adjust valve |
| 49. | USB input/output connector/com. line | 104. | Actuator drive accumulator |
| 50. | Actuator timer | 105. | Actuator solenoid |
| 51. | Left lung pressure gauge | 106. | CO2 concentration sensor |
| 52. | Left lung pleural pressure gauge | 160. | Elastic membrane attachment plate |
| 107. | User Interface | 161. | Asymmetric Airways resistances module |
| 108. | Power input | 162. | Airways volume compartment |
| 109. | Lower Airway Volume Adjustment | 163. | Inspiratory flow channel |
| 110. | Pleural Cavity pressure adjustment valve | 164. | Expiratory flow channel |
| 111. | Wireless input/output | 165. | Inspiratory flow one-way valve |
| 112. | Non-invasive mask adaptor airway | 166. | Expiratory flow one-way valve |
| 113. | Drain, Lung Cavity compartment | 167. | Upper airway flow channel |
| 114. | Drain access port | 168. | Flow manifold |
| 115. | Lobe 1 | 169. | Inspiratory resistance setting mechanism |
| 116. | Lobe 2 | 170. | Expiratory resistance setting mechanism |
| 117. | Lower Airway volume dual lobe | 171. | COPD expiratory flow resistance module |
| 118. | Lobe 1 compliance | 172. | Collapsible lower airway/Flow path |
| 119. | Lobe 2 compliance | 173. | Outer compartment |
| 120. | COPD normally closed airway | 174. | Pressure signal conduit |
| 121. | COPD airway distension channel | 175. | Positive pressure |
| 122. | COPD airway housing | 176. | Collapsed airway |
| 123. | Dual lobe lung upper airway manifold | 177. | Negative pressure |
| 124. | Dual lobe lung upper airway channel | 178. | Propped open airway |
| 125. | Upper Airway humidifier | 179. | Collapsible upper airway module (OSA) |
| 126. | Upper Airway humidity | 180. | Upper airway tube |
| 127. | Outer enclosure | 181. | Airway collapse mechanism |
| 128. | Inner bottom chassis | 182. | Linear resistance adjustment mechanism |
| 129. | Bottom chassis height adjust mechanism | 183. | Parabolic resistance adjust mechanism |
| 130. | Bottom chassis height setting clamp | 184. | Adjustment needle |
| 131. | Right chest compliance spring | 185. | Pincher needle |
| 132. | Left chest compliance spring | 186. | Flow path |
| 133. | Compliance spring bearing | 187. | ET tube resistance insert |
| 134. | Breath effort actuator | 188. | ET tube leak adjust |
| 135. | Breath effort actuator plate | 189. | Ventilator breathing circuit wye connector |
| 136. | Breath effort actuator cable | 190. | O2 consumption recirculating module |
| 137. | Cable pivot joint | 200. | Lung Simulator 1 (FIG. 1) |
| 138. | Cable diaphragm plate joint | 201. | Lung Simulator 2 (FIG. 9) |
| 139. | Adjustable Airways volume | 202. | Lung Simulator 3 (FIG. 15) |
| 140. | Airways volume adjustment mechanism | 203. | Lung Simulator 4 (FIG. 16) |
| 141. | Airways volume dashpot | 204. | Lung simulator 5 (FIG. 21) |
| 142. | Abdominal cavity top plate | 205. | Lung simulator 6 (FIG. 25) |
| 143. | Abdominal cavity top plate bearing | D. | Distal (toward lung) |
| 144. | Diaphragm lateral slide hinge | P. | Proximal (away from lung) |
| 145. | Diaphragm plate center flex joint | a | Abdominal cavity pressure sensor |
| 146. | Uni-Diaphragm plate | b | Pleural cavity pressure sensor |
| 147. | Diaphragm plate breath effort actuator | c | Alveolar cavity pressure sensor |
| 148. | Compliance adjustment upper slide | d | Balancing flow rate flow sensor |
| 149. | Compliance adjustment lower slide | e | CO2 diffusion flow rate flow sensor |
| 150. | Sliding Compliance spring | f | Lower airway pressure sensor |
| 151. | Cardiogenic signal generator | g | Upper airway pressure sensor |
| 152. | Pleural adhesion element | h | Inhaled/exhaled flow sensor |
| 153. | Uni-diaphragm plate 2 | | |
| 154. | Uni-diaphragm plate anti-wobble balancer | | |
| 155. | Uni-diaphragm plate compliance spring | | |
| 156. | Uni-diaphragm plate breath effort actuator | | |
| 157. | Uni-diaphragm stroke bellows | | |
| 158. | Uni-diaphragm rigid plate | | |
| 159. | Uni-diaphragm elastic membrane | | |

1. A lung simulator with an at least three-compartment lung, comprising an outer compartment pleural cavity, and an inner compartment lung volume within the outer compartment, the inner compartment comprising (1) a physiologic volume first sub-compartment and (2) a lower airway dead space second sub-compartment.

2. A lung simulator as in claim 1 wherein the pleural cavity comprises an outer wall simulating the visceral pleura, and an inner wall simulating the parietal pleura.

3. A lung simulator as in claim 1 wherein the pleural cavity comprises an outer wall simulating the visceral pleura, and an inner wall simulating the parietal pleura, and further wherein the outer wall and inner wall are attracted together with a connection, the connection adapted to act as a dashpot, a spring, a frictional coupling, a viscous coupling, or any combination thereof.

4. A lung simulator as in claim 1 wherein the pleural cavity comprises an outer wall simulating the visceral pleura, an inner wall simulating the parietal pleura, and an adjustable connection between the two walls, wherein the connection comprises (a) in a first connected state wherein the connection attracts the inner wall to the outer wall with a first force, and (b) a second connected state wherein the connection attracts the inner wall to the outer wall with a second force, and (c) a third disconnected state wherein the inner wall is substantially unattracted to the outer wall.

5. A lung simulator as in claim 1 wherein the physiologic volume first sub-compartment comprises an atmosphere airway opening, and wherein the lower airway sub-compartment is on the distal side of the airway opening.

6. A lung simulator as in claim 1 wherein the lower airway volume sub-compartment is in series with the physiologic volume sub-compartment.

7. A lung simulator as in claim 1 with a spontaneous breathing actuator.

8. A lung simulator as in claim 1 with a three-compartment left lung and a three-compartment right lung.

9. A lung simulator as in claim 1 with an outer compartment pleural cavity, and a left lung inner compartment and a right lung inner compartment both within the outer compartment, and a left lower airway compartment and right lower airway compartment within the left and right lung inner compartments respectively.

10. A lung simulator as in claim 1 wherein the outer compartment comprises a wall, and further comprising a diaphragm plate coupled to the outer compartment outside wall.

11. A lung simulator as in claim 1 further comprising a space between the outer and inner compartments and a pneumatic connection between the space and the inner compartment, the connection open-able and closeable, and adapted to apply the addition or removal of air from the space between the two compartments to create a vacuum pressure or atmospheric pressure or positive pressure, and wherein in a first closed state with an applied vacuum in the space the wall of the inner compartment is attracted to the wall of outer compartment with a first force, and in a second closed state with a second applied vacuum in the space the inner compartment wall is attracted to the outer compartment wall with a second force, and wherein in a first open state the inner compartment wall is not attracted to the outer compartment wall.

12. A lung simulator as in claim 1 further comprising (a) a chest wall frame, (b) a diaphragm plate, wherein the diaphragm plate is (1) coupled to the outer compartment wall and (2) coupled to the chest wall frame with a hinge-type connection, and (c) a spontaneous breathing actuator which deflects the diaphragm plate pivoting the plate about the hinged-type connection.

13. A lung simulator as in claim 1 comprising a proximal end defining the outside atmospheric air entrance to the simulator and a distal end defining the deepest inside section of the simulator (a) an upper airway connection between the inner compartment and atmosphere, (b) a lower airway sub-compartment resistance adjustment and (c) a lung compliance adjustment, wherein the resistance adjustment is distal to the atmosphere connection.

14. A lung simulator as in claim 1 comprising an opening between the inner compartment and atmosphere, the opening connectable to a humidified source of air, and comprising a drain in the inner compartment to drain water.

15. A lung simulator as in claim 1 further comprising a module pneumatically connectable to the lower airway sub-compartment, the module comprising tubular structures pneumatically communicating with the lower airway sub-compartment, the tubular structures either (a) normally collapsed and expandable during distal direction airflow, or (b) normally open and collapsible during proximal direction air flow.

16. A lung simulator as in claim 1 comprising a lung volume deflation adjustment member, the member adjustable to set one or more degrees of deflation.

17. A lung simulator as in claim 1 wherein the inner compartment comprises a first volume, and the simulator further comprises an inner compartment volume adjustment, and wherein the second sub-compartment lower airway volume includes an air flow resistance adjustment, and wherein the first outer compartment comprises a spring compliance, and wherein the volume adjustment, resistance adjustment and compliance adjustment include a scale, the scale optionally electronically readable.

18. A lung simulator as in claim 1 wherein the parameters are provided as an output to a computer-based user interface, the interface including an anatomically representative lung graphic, the graphic automatically alterable to represent the lung simulator and with the parameter displayed, such as lung pressure and muscle effort.

19. A lung simulator as in claim 1 comprising a CO2 diffusion system for delivering a controlled volumetric flowrate of CO2 gas into the inner physiologic volume sub-compartment, and measuring the CO2 concentration in the simulator.

20. A lung simulator as in claim 1 further comprising (1) a manifold coupled to the inner and outer compartment, (2) a spring element coupled to the inner compartment, (3) a top frame coupled to the manifold, (4) a bottom frame coupled to the top frame, (5) an adjustment between the top and bottom frame wherein the top frame can be raised or lowered, the adjustment comprising at least two settings wherein a first setting enacts a first volume of the physiologic sub-compartment, and a second setting enacts a second volume of the physiologic sub-compartment; and further wherein the spring element force is the same at the at least two volume settings, thus simulating at least two different residual volumes of the lung simulator with a residual volume adjustment that can be adjusted without adjusting the compliance of the lung.

20. A lung simulator as in claim 1 further comprising a second sub-compartment physiologic volume in the inner compartment, the first and second physiologic volume sub-compartments representing two separate lung sections, including two lung lobes, a left lung and a right lung, or two lung segments.
